(19) United States
(12) Patent Application Publication
(10) Pub. No.: US 2015/0116258 A1
(43) Pub. Date: Apr. 30, 2015

(54) METHOD AND DEVICE FOR LOCATING TOUCH POINT AND ELECTRONIC EQUIPMENT

(71) Applicants: Tianma Micro-Electronics Co., Ltd., Shenzhen (CN); Shanghai AVIC Optoelectronics Co., Ltd., Shanghai (CN)

(72) Inventors: Xiangchun Wang, Shanghai (CN); Xupeng Wang, Shanghai (CN)

(73) Assignees: Tianma Micro-Electronics Co., Ltd., Shenzhen (CN); Shanghai AVIC Optoelectronics Co., Ltd., Shanghai (CN)

(21) Appl. No.: 14/220,051

(22) Filed: Mar. 19, 2014

(30) Foreign Application Priority Data
Oct. 31, 2013 (CN) 201310534711.2

(51) Int. Cl. G06F 3/044

(52) U.S. Cl. CPC G06F 3/044
USPC 345/174

(57) ABSTRACT

The present invention relates to a method and a device for locating a touch point on a touch region, and an electronic equipment, wherein the touch region comprises a plurality of partitions. The method includes detecting a current value of a parameter of each partition, and acquiring a reference value of the parameter and a preset threshold value of the parameter; determining a touched partition according to the current value of the parameter, the reference value of the parameter and the preset threshold value; scanning the touched partition to locate at least one touch point. The method also includes scanning at least one partition adjacent to the touched partition to locate the touch point while the touched partition is being scanned.

### CROSS-REFERENCES TO RELATED APPLICATIONS

This application claims the benefit of priority to Chinese Patent Application No. 201310534711.2, filed with the Chinese Patent Office on Oct. 31, 2013 and entitled “METHOD AND DEVICE FOR LOCATING TOUCH POINT AND ELECTRONIC EQUIPMENT”, the content of which is incorporated herein by reference in its entirety.

### TECHNICAL FIELD

The present invention relates to the field of touch panels, in particular to a method and a device for locating a touch point and an electronic equipment.

### BACKGROUND OF THE INVENTION

Touch panels are currently the most simple, convenient and natural human-computer interface devices, which have been generally used in applications such as public information inquiries, industrial control, military command, videogame, song and food ordering, and multimedia teaching.

Touch panels generally include resistive touch panels and capacity touch panels. In the capacity touch panel, a transparent conductive metal layer is attached to the surface of a glass layer, so that the capacity touch panel operates in the current sensing principle to the human body. When a finger touches the touch panel, progressive line-by-line scanning is performed using scan lines along an X-axis direction and a Y-axis direction to detect a capacitance change, so that the location of the touch point can be determined from the capacitance change.

In locating the touch point, the continuous progressive line-by-line scanning is performed using the scan lines in the entire touch panel, thus the time for such locating is prolonged due to a large scan area, and the efficiency of locating the touch point is low.

### BRIEF SUMMARY OF THE INVENTION

Embodiments of the present invention provide a method and a device for locating a touch point and an electronic equipment, for solving the technical problems described above.

Embodiments of the present invention provide a method for locating a touch point on a touch region having a number of partitions. The method comprises:

detecting a current value of a parameter of each partition, and acquiring a reference value of the parameter and a preset threshold value of the parameter;

determining a touched partition according to the current value of the parameter, the reference value of the parameter and the preset threshold value; and

scanning the touched partition to locate at least one touch point.

Embodiments of the present invention also provides a device for locating a touch point on a touch region having a number of partitions. The device includes:

a detecting and acquiring module configured to detect a current value of a parameter of each partition and acquire a reference value of the parameter and a preset threshold value of the parameter;

acquiring the current value of the parameter in a Y-axis direction and a coordinate of a peak location in the Y-axis direction, and comparing the current value of the parameter in the Y-axis direction with the reference value of the parameter in the Y-axis direction, to obtain a changed value of the parameter in the Y-axis direction;

determining orthogonal coordinates constituted by the coordinate of the peak location in the X-axis direction and the coordinate of the peak location in the Y-axis direction as coordinates of the touch point, if both the changed value of the parameter in the X-axis direction and the changed value of the parameter in the Y-axis direction are larger than the respective preset threshold values.

The present invention further provides an electronic equipment including a display unit and a device for locating a touch point as described above.

The method and device for locating a touch point and the electronic equipment provided by the present invention are characterized by: determining the touched partition and scanning the touched partition to locate the touch point, so that the scanned area is reduced, the scanning time is shortened and the efficiency of locating the touch point is improved.

### BRIEF DESCRIPTION OF THE DRAWINGS

In order to make the technical solutions of the embodiments of the present invention or of the prior art more apparent, the accompanying drawings used for the description of the embodiments or the prior art will be briefly introduced below. The drawings in the description below illustrate only specific embodiments of the invention, and modifications can be made in light of the provided drawings by those ordinary skilled in the art without creative work.

FIG. 1 is a schematic flowchart of a method for locating a touch point according to a first embodiment of the present invention;

FIG. 2 is a schematic flowchart of a method for determining touched partitions according to current values of at least one parameter, reference values of the parameters and preset threshold values according to the first embodiment of the present invention;

FIG. 3 is a schematic flowchart of a method for scanning the touched partitions and locating at least one touch point according to the first embodiment of the present invention;

FIG. 4 is a schematic flowchart of a method for locating a touch point according to a second embodiment of the present invention;

FIG. 5 is a schematic flowchart of a method for locating a touch point according to a third embodiment of the present invention;

FIG. 6 is a schematic diagram showing a device for locating a touch point according to a fourth embodiment of the present invention;

FIG. 7 is a schematic diagram showing a device for locating a touch point according to a fifth embodiment of the present invention; and

FIG. 8 is a schematic diagram showing a device for locating a touch point according to a sixth embodiment of the present invention.

### DETAILED DESCRIPTION OF THE INVENTION

The following clearly and thoroughly describes the technical solutions in embodiments of the present invention with reference to the accompanying drawings. The described embodiments are merely specific embodiments rather than all embodiments of the present invention. Any embodiments obtained by persons of ordinary skill in the art based on the described embodiments of the present invention without creative efforts shall fall within the protection scope of the claims.

### First Embodiment

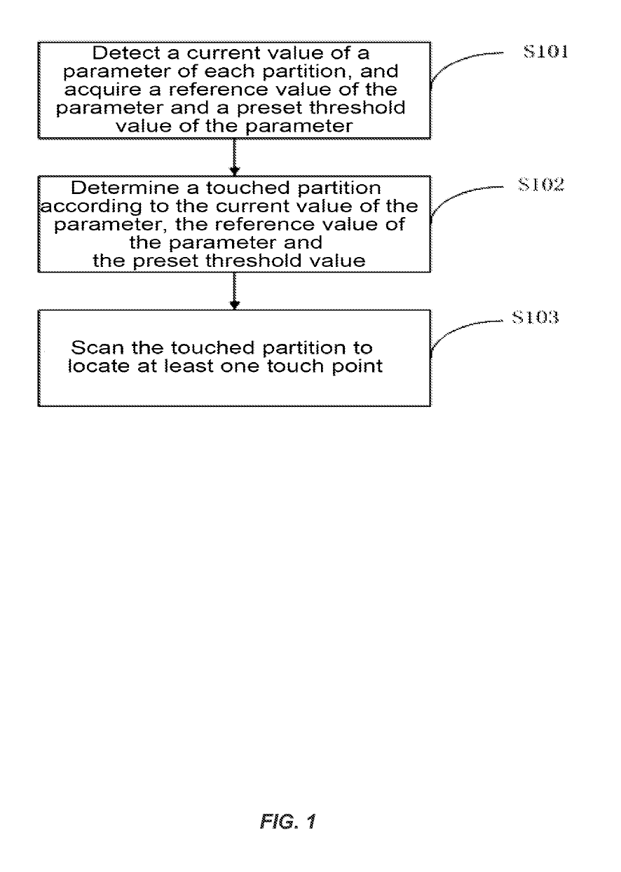

As shown in FIG. 1, a first embodiment of the present invention discloses a method for locating a touch point on a touch region having a number of partitions. The method includes Steps S101 to S103 as described below in detail.

At Step S101, a current value of a parameter of each partition is detected, and a reference value of the parameter and a preset threshold value of the parameter are acquired.

In Step S101, a region for scanning is divided into a plurality of partitions. Each partition may have a different or a same area and a different or same shape. For example, a region with frequent occurrences of touches (i.e. a frequently touch region) may be divided into partitions each with a small area, thereby increasing the number of the partitions and improving the precision in locating the touch point; while a region with rare occurrences of touches may be divided into partitions each with a large area, thereby reducing the number of the partitions and, hence reducing the power consumption for locating the touch point.

If a touch panel is a capacity touch panel, the parameter of each partition is a capacitance of the partition, the current value of the parameter of each partition is the current capacitance of the partition (the partition may be touched or may not be touched at that moment), the reference value of the parameter of each partition is a capacitance of the partition which have not been touched and when touch panels are in a normal operation condition. If a touch panel is a resistive touch panel, the parameter of each partition is a resistance value of the partition, the current value of the parameter of each partition is the current resistance value of the partition (the partition may be touched or may not be touched at the moment), the reference value of the parameter of each partition is a resistance value of the partition which have not been touched and when touch panels are in a normal operation condition.

The preset threshold value is a determining threshold to determine whether the partition has been touched.

The reference value of each parameter and the preset threshold value may be previously set and stored.

At Step S102, a touched partition is determined according to the current value of the parameter, the reference value of the parameter and the preset threshold value.

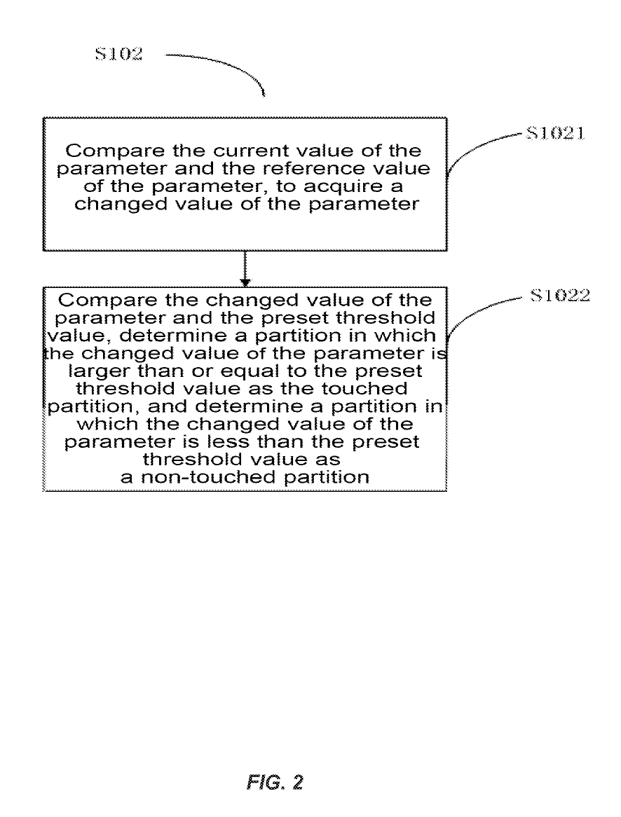

As shown in FIG. 2, Step 102 in a first embodiment of the present invention specifically includes the following Steps S1021 and S1022.

At Step S1021, the current value of the parameter is compared with the reference value of the parameter to obtain a changed value of the parameter. It should be noted that a difference value between the current value of the parameter and the reference value of the parameter is set as the changed value of the parameter.

At Step S1022, the changed value of the parameter is compared with the preset threshold value, and a partition in which the changed value of the parameter is larger than or equal to the preset threshold value is determined as a touched partition, while a partition in which the changed value of the parameter is less than the preset threshold value is determined as a non-touched partition.

At Step S103, the touched partition is scanned to locate at least one touch point.

There are many methods for scanning to determine the touched point in the prior art, a method according to an embodiment of the present invention is as follows.

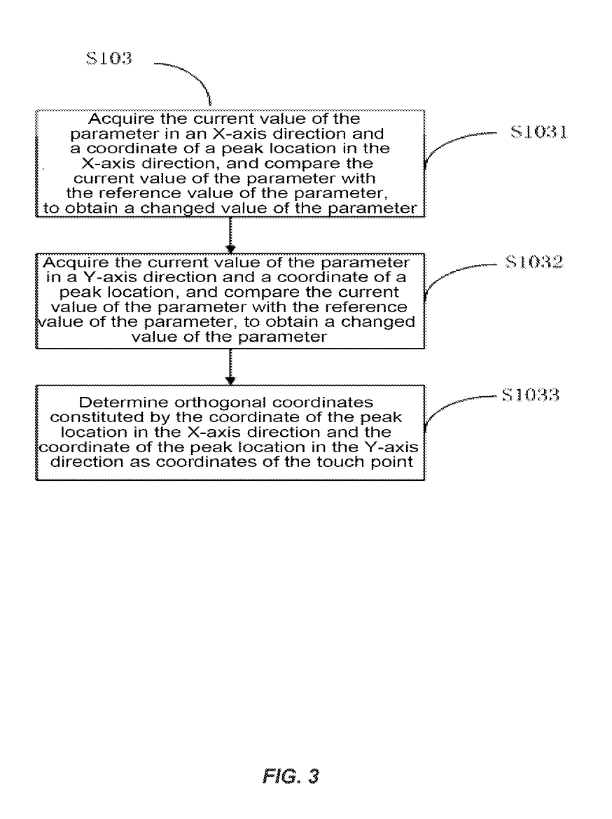

As shown in FIG. 3, Step 103 in the embodiment of a present invention includes the following Steps S1031 and S1033.

At Step S1031, in the touched partition, a current value of the parameter in an X-axis direction and a coordinate of a peak location in the X-axis direction are acquired, and the acquired current value of the parameter is compared with a reference value of the parameter in the X-axis direction, to obtain a changed value of the parameter in the X-axis direction.

At Step S1032, in the touched partition, a current value of the parameter in a Y-axis direction and a coordinate of a peak location in the Y-axis direction are acquired, and the acquired current value of the parameter is compared with a reference value of the parameter in the Y-axis direction, to obtain a changed value of the parameter in the Y-axis direction.

At Step S1033, if both the changed value of the parameter in the X-axis direction and the changed value of the parameter in the Y-axis direction are larger than the respective preset threshold values, the coordinate of the peak location in the X-axis direction and the coordinate of the peak location in the Y-axis direction constitute orthogonal coordinates which are determined as coordinates of the touch point.

The detailed description of the method for locating the touched point by using the peak location may be referenced to the Chinese patent application No. 201110415900.9, the content of which is incorporated herein by reference in its entirety.

By using the method for locating a touch point which is disclosed in a first embodiment of the present invention, the touched partition and the non-touched partition are determined, and the scan lines are driven to scan the touched partition so as to locate the touch point, so that the area scanned by using the scan lines is reduced, the scanning time is shortened and the efficiency of locating the touch point is improved.

### Second Embodiment

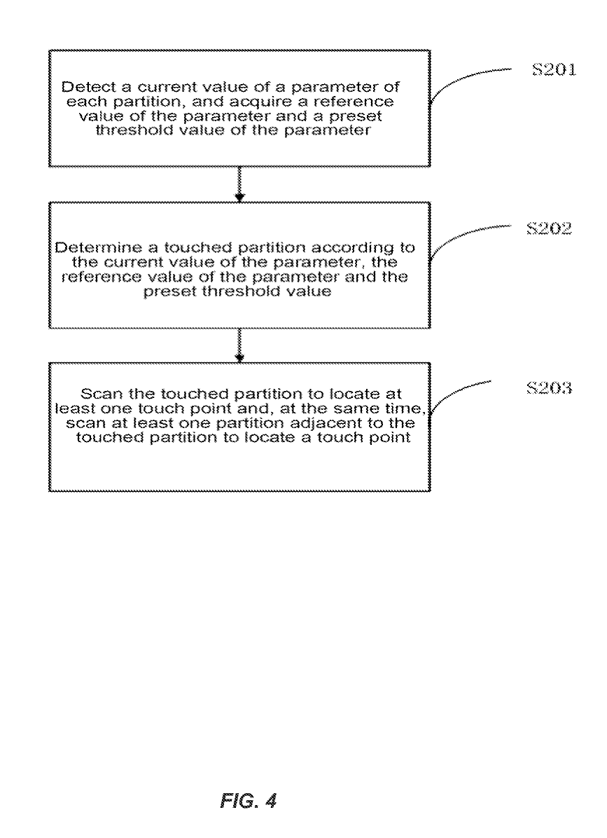

As shown in FIG. 4, a second embodiment of the present invention discloses a method for locating a touch point, and the method includes Steps S201 to S203 as described below in detail.

At Step S201, a current value of a parameter of each partition is detected, and a reference value of the parameter and a preset threshold value of the parameter are acquired.

At Step S202, a touched partition is determined according to the current value of the parameter, the reference value of the parameter and the preset threshold value.

At Step S203, the touched partition is scanned to locate at least one touch point, at the same time, at least one partition adjacent to the touched partition is scanned to locate a touch point.

By using the method for locating a touch point which is disclosed in the second embodiment of the present invention, the scanned area is enlarged because at least one partition adjacent to the touched partition is scanned, thereby improving the precision in locating the touch point.

### Third Embodiment

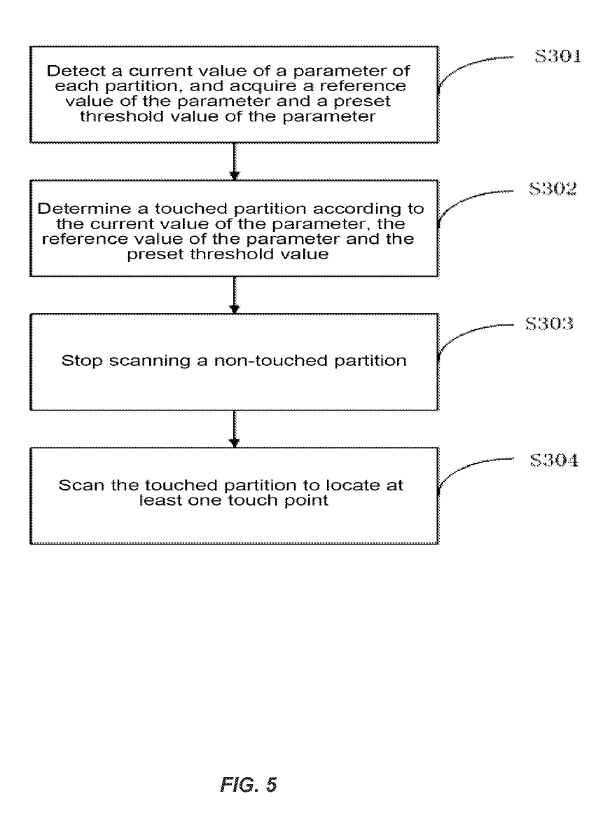

In locating a touch point in the prior art, drive lines and scan lines are always in an operating state, and hence interfere with each other, as a result, interference noises are produced. Based on the first embodiment, a third embodiment of the present invention discloses a method for locating a touch point, as shown in FIG. 5, and the method includes Steps S301 to S304 as described below in detail.

At Step S301, a current value of a parameter of each partition is detected, and a reference value of the parameter and a preset threshold value of the parameter are acquired.

At Step S302, a touched partition is determined according to the current value of the parameter, the reference value of the parameter and the preset threshold value.

At Step S303, the scanning for a non-touched partition is stopped.

At Step S304, the touched partition is scanned to locate at least one touch point.

By using the method for locating a touch point which is disclosed in a third embodiment of the present invention, drive lines and scan lines in the non-touched partition are disabled to stop the scanning for the non-touched partition, thereby reducing the interference between the drive lines and the scan lines, and improving the precision in locating the touch point while reducing the interference noises.

### Fourth Embodiment

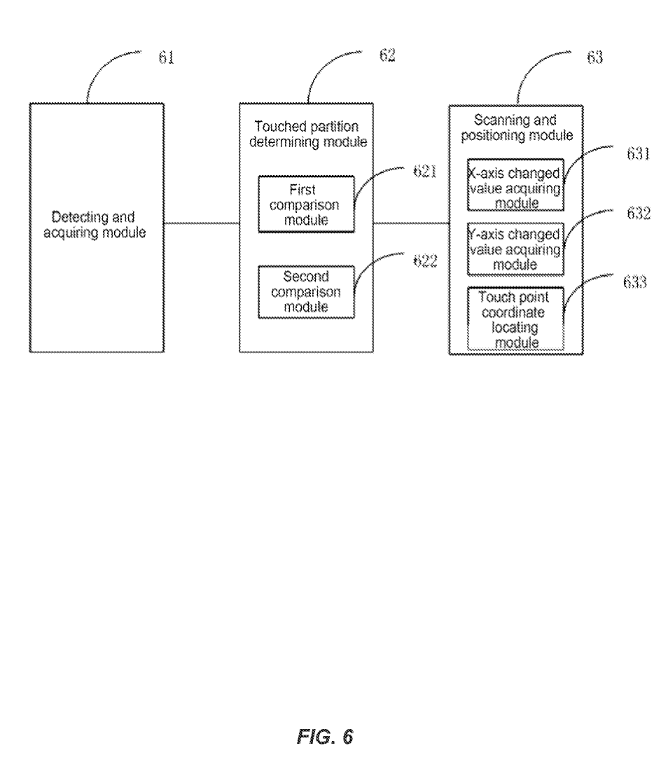

Based on the method for locating a touch point as disclosed in the first embodiment of the present invention, a fourth embodiment of the present invention discloses a device for locating a touch point on a touch region including a number of partitions, as shown in FIG. 6. The device includes a detecting and acquiring module 61, a touched partition determining module 62, and a scanning and locating module 63.

It should be noted that, in an application, the detecting and acquiring module 61 and the scanning and locating module 63 correspond to drive lines and scan lines, respectively; and the touched partition determining module 62 corresponds to an integrated circuit chip. The drive lines supply power to the scan lines to scan the respective partitions using the scan lines, to detect a current value of each parameter in each of the partitions; further, the scan lines may be used for scanning the touched partition to obtain the current value of the parameter and the coordinate of a peak location in the X-axis direction as well as the current value of the parameter and the coordinate of a peak location in the Y-axis direction. If the drive lines stop supplying power to the scan lines, the scanning based on the scan lines stops. The integrated circuit chip is configured to store a reference value of each parameter and a preset threshold value, and process various data detected by the scan lines, to determine the touched partition and locate the touch point. Of course, the above corresponding relationship is illustrative only, and is not intended to limit the embodiment of the present invention.

The detecting and acquiring module 61 is configured to detect the current value of a parameter of each partition and acquire the reference value of the parameter and the preset threshold value.

The touched partition determining module 62 is configured to determine the touched partition according to the current value of the parameter, the reference value of the parameter and the preset threshold value.

The scanning and locating module 63 is configured to scan the touched partition to locate at least one touch point.

The touched partition determining module 62 includes a first comparison module 621 and a second comparison module 622.

The first comparison module 621 is configured to compare the current value of each parameter with the reference value of the parameter, to obtain a changed value of the parameter.

The second comparison module 622 is configured to compare the changed value of each parameter with the preset threshold value, and determine a partition in which the changed value of the parameter is larger than the preset threshold value as a touched partition, while determine a partition in which the changed value of the parameter is less than the preset threshold value as a non-touched partition.

The scanning and locating module 63 includes an X-axis changed value acquiring module 631, a Y-axis changed value acquiring module 632 and a touch point coordinate locating module 633.

The X-axis changed value acquiring module 631 is configured to acquire a current value of the parameter in the X-axis direction and the coordinate of a peak location in the X-axis direction in the touched partition, and compare the acquired current value of the parameter with a reference value of the parameter in the X-axis direction, to obtain a changed value of the parameter in the X-axis direction.

The Y-axis changed value acquiring module 632 is configured to acquire a current value of the parameter in the Y-axis direction and the coordinate of a peak location in the Y-axis direction in the touched partition, and compare the acquired current value of the parameter with a reference value of the parameter in the Y-axis direction, to obtain a changed value of the parameter in the Y-axis direction.

The touch point coordinate locating module 633 is configured to determine orthogonal coordinates constituted by the coordinate of the peak location in the X-axis direction and the coordinate of the peak location in the Y-axis direction as coordinates of the touch point, if both the changed value of the parameter in the X-axis direction and the changed value of the parameter in the Y-axis direction are larger than the respective preset threshold values.

By using the device for locating a touch point which is disclosed in a fourth embodiment of the present invention, the touched partition and the non-touched partition are determined, and the scan lines are driven to scan the touched partition so as to locate the touch point, so that the area scanned by using the scan lines is reduced, the scanning time is shortened and the efficiency of locating the touch point is improved.

### Fifth Embodiment

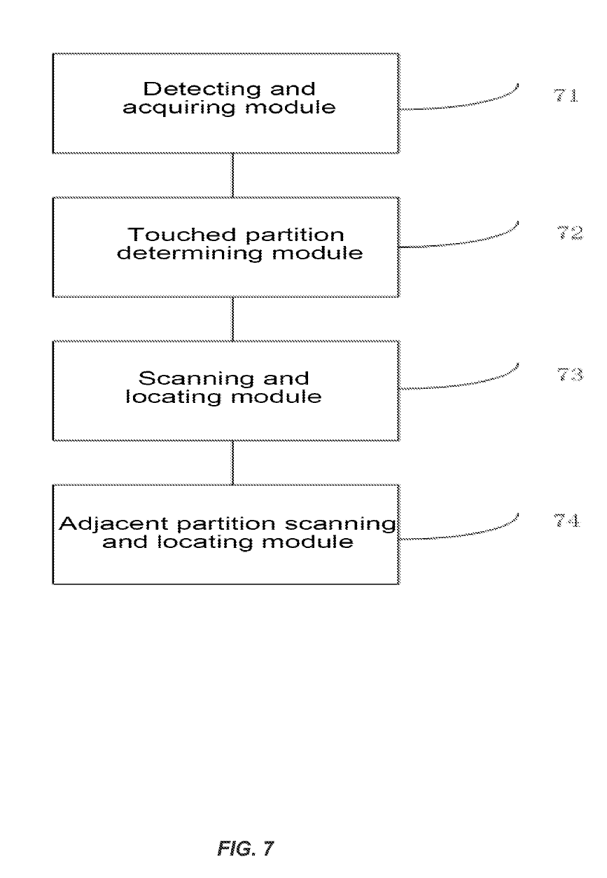

Based on the method for locating a touch point in the second embodiment of the present invention, a fifth embodiment of the present invention discloses a device for locating a touch point, as shown in FIG. 7. The device includes a detecting and acquiring module 71, a touched partition determining module 72, a scanning and locating module 73 and an adjacent partition scanning and locating module 74.

The detecting and acquiring module 71 is configured to detect a current value of a parameter of each partition and acquire a reference value of the parameter and a preset threshold value of the parameter.

The touched partition determining module 72 is configured to determine a touched partition according to the current value of the parameter, the reference value of the parameter and the preset threshold value.

The scanning and locating module 73 is configured to scan the touched partition to locate at least one touch point.

The adjacent partition scanning and locating module 74 is configured to scan at least one partition adjacent to the touched partition that is scanned by the scanning and locating module 73.

By using the device for locating a touch point which is disclosed in a fifth embodiment of the present invention, the scanned area is enlarged because at least one partition adjacent to the touched partition is scanned, thereby improving the precision in locating the touch point.

### Sixth Embodiment

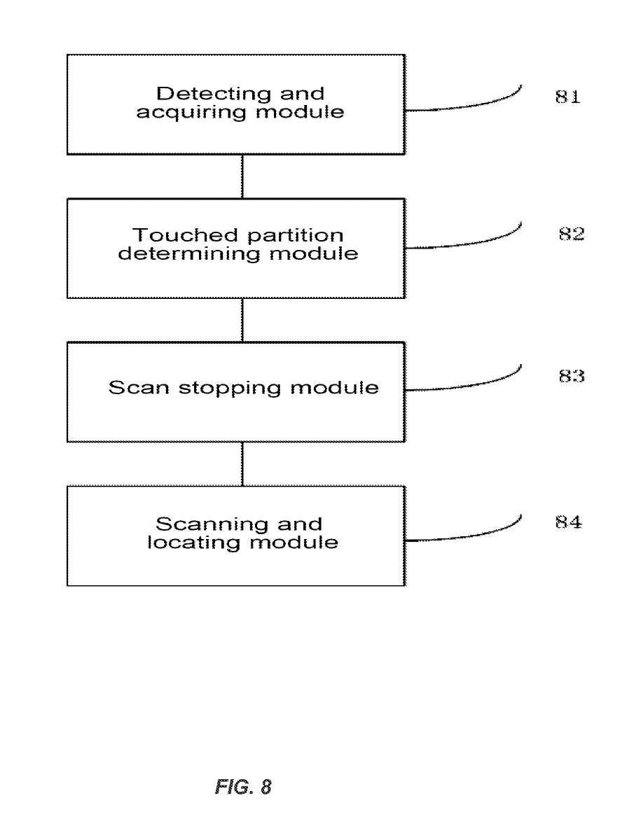

Based on the method for locating a touch point disclosed in the third embodiment of the present invention, a sixth embodiment of the present invention discloses a device for locating a touch point on a touch region including a number of partitions, as shown in FIG. 8. The device includes a detecting and acquiring module 81, a touched partition determining module 82, a scan stopping module 83 and a scanning and locating module 84.

The detecting and acquiring module 81 is configured to detect a current value of a parameter of each partition and acquire a reference value of the parameter and a preset threshold value of the parameter.

The touched partition determining module 82 is configured to determine a touched partition according to the current value of the parameter, the reference value of the parameter and the preset threshold value.

The scan stopping module 83 is configured to stop scanning a non-touched partition after the touched partition is determined according to the current value of the parameter, the reference value of the parameter and the preset threshold value.

The scanning and locating module 84 is configured to scan the touched partition to locate at least one touch point.

By using the method for locating a touch point which is disclosed in a sixth embodiment of the present invention, drive lines and scan lines in the non-touched partition are disabled to stop the scanning for the non-touched partition, thereby reducing the interference between the drive lines and the scan lines, and improving the precision in locating the touch point meanwhile reducing the noise.

### Seventh Embodiment

A seventh embodiment of the present invention discloses an electronic equipment including a display unit and a device for locating a touch point on a touch region as described in any one of the above embodiments.

It should be noted that the display unit may be a touch panel. Electronic equipment may be a mobile terminal running an operating system such as Android (which is an operating system platform developed by Google Inc. for portable mobile smart devices), iOS (which is an operating system platform developed by Apple Inc. for portable mobile smart devices), and Windows Phone (which is an operating system platform developed by Microsoft for portable mobile smart devices). The mobile terminal may be any one of a mobile phone, a palmtop computer, a tablet computer and on the like. A display unit may be a stationary human-computer interaction terminal, such as an automatic teller machine or an information kiosk. Of course, the above exemplary devices are illustrative only, and are not intended to limit the embodiments of the present invention.

Apparently, one of ordinary skilled in the art will be appreciated that the various modules and steps of the present invention may be realized by a general purpose computing device, particularly integrated in a single computing device or distributed in a network composed of a plurality of the computing devices. Alternatively, the various modules and steps can be realized by computer-executable codes which may be stored in a storage device and executed by the computing device, the various modules and steps can be embodied by various integrated circuit modules, or some of the modules or steps can be embodied by a single integrated circuit module. Thus, the present invention is not limited to specific hardware, software, or any combination thereof

Preferred embodiments of the present invention have been described above, but are not intended to be limiting the present invention. Various modifications and variations may be made based on the present invention by one skilled in the art. Thus, although the invention has been described with respect to specific embodiments, it will be appreciated that the invention is intended to cover all modifications and equivalents within the scope of the following claims.

What is claimed is:

1. A method for locating a touch point on a touch region comprising a plurality of partitions, the method comprising:
detecting a current value of a parameter of each partition, and acquiring a reference value of the parameter and a preset threshold value of the parameter;
determining a touched partition according to the current value of the parameter, the reference value of the parameter and the preset threshold value; and
scanning the touched partition to locate at least one touch point.

2. The method of claim 1, further comprising:
scanning at least one partition adjacent to the touched partition to locate the touch point while the touched partition is being scanned.

3. The method of claim 1, wherein determining a touched partition according to the current value of the parameter, the reference value of the parameter and the preset threshold value comprises:
comparing the current value of the parameter with the reference value of the parameter to acquire a changed value of the parameter; and
comparing the changed value of the parameter with the preset threshold value, determining a partition in which the changed value of the parameter is larger than or equal to the preset threshold value as the touched partition, and determining a partition in which the changed value of the parameter is less than the preset threshold value as a non-touched partition.

4. The method of claim 3, further comprising, after determining a touched partition according to the current value of the parameter, the reference value of the parameter, and the preset threshold value:
stopping scanning the non-touched partition.

5. The method of claim 1, wherein scanning the touched partition to locate at least one touch point comprises:
acquiring the current value of the parameter in an X-axis direction and a coordinate of a peak location in the X-axis direction in the touched partition, and comparing the current value of the parameter with the reference value of the parameter in the X-axis direction, to obtain a changed value of the parameter in the X-axis direction;
acquiring the current value of the parameter in a Y-axis direction and a coordinate of a peak location in the Y-axis direction, and comparing the current value of the parameter in the Y-axis direction with the reference value of the parameter in the Y-axis direction, to obtain a changed value of the parameter in the Y-axis direction; and
determining orthogonal coordinates constituted by the coordinate of the peak location in the X-axis direction and the coordinate of the peak location in the Y-axis direction as coordinates of the touch point, if both the changed value of the parameter in the X-axis direction and the changed value of the parameter in the Y-axis direction are larger than the respective preset threshold values.

6. The method of claim 2, wherein scanning the touched partition to locate at least one touch point comprises:
acquiring the current value of the parameter in an X-axis direction and a coordinate of a peak location in the X-axis direction in the touched partition, and comparing the current value of the parameter with the reference value of the parameter in the X-axis direction, to obtain a changed value of the parameter in the X-axis direction;
acquiring the current value of the parameter in a Y-axis direction and a coordinate of a peak location in the Y-axis direction, and comparing the current value of the parameter in the Y-axis direction with the reference value of the parameter in the Y-axis direction, to obtain a changed value of the parameter in the Y-axis direction; and
determining orthogonal coordinates constituted by the coordinate of the peak location in the X-axis direction and the coordinate of the peak location in the Y-axis direction as coordinates of the touch point, if both the changed value of the parameter in the X-axis direction and the changed value of the parameter in the Y-axis direction are larger than the respective preset threshold values.

7. A device for locating a touch point on a touch region including a plurality of partitions, the device comprising:
a detecting and acquiring module configured to detect a current value of a parameter of each partition and acquire a reference value of the parameter and a preset threshold value of the parameter;
a touched partition determining module configured to determine a touched partition according to the current value of the parameter, the reference value of the parameter and the preset threshold value; and
a scanning and locating module configured to scan the touched partition to locate at least one touch point.

8. The device of claim 7, further comprising:
an adjacent partition scanning and locating module configured to scan at least one partition adjacent to the touched partition while the touched partition is being scanned.

9. The device of claim 7, wherein the touched partition determining module comprises:
a first comparing module configured to compare the current value of the parameter with the reference value of the parameter to acquire a changed value of the parameter;
a second comparing module configured to compare the changed value of the parameter with the preset threshold value, determine a partition in which the changed value of the parameter is larger than or equal to the preset threshold value as the touched partition, and determine a partition in which the changed value of the parameter is less than the preset threshold value as a non-touched partition.

10. The device of claim 9, further comprising:
a scan stopping module configured to stop scanning the non-touched partition after the touched partition has been determined according to the current value of the parameter, the reference value of the parameter and the preset threshold value.

11. The device of claim 7, wherein the scanning and locating module comprises:
an X-axis changed value acquiring module configured to acquire the current value of the parameter in an X-axis direction and a coordinate of a peak location in the X-axis direction in the touched partition, and compare the current value of the parameter with the reference value of the parameter in the X-axis direction, to obtain a changed value of the parameter in the X-axis direction;
an Y-axis changed value acquiring module configured to acquire the current value of the parameter in a Y-axis direction and a coordinate of a peak location in the Y-axis direction, and compare the current value of the parameter in the Y-axis direction with the reference value of the parameter in the Y-axis direction, to obtain a changed value of the parameter in the Y-axis direction; and
a touch point coordinate locating module configured to determine orthogonal coordinates constituted by the coordinate of the peak location in the X-axis direction and the coordinate of the peak location in the Y-axis direction as coordinates of the touch point, if both the changed value of the parameter in the X-axis direction and the changed value of the parameter in the Y-axis direction are larger than the respective preset threshold values.

12. The device of claim 8, wherein the scanning and locating module comprises:
an X-axis changed value acquiring module configured to acquire the current value of the parameter in an X-axis direction and a coordinate of a peak location in the X-axis direction in the touched partition, and compare the current value of the parameter with the reference value of the parameter in the X-axis direction, to obtain a changed value of the parameter in the X-axis direction;
an Y-axis changed value acquiring module configured to acquire the current value of the parameter in a Y-axis direction and a coordinate of a peak location in the Y-axis direction, and compare the current value of the parameter in the Y-axis direction with the reference value of the parameter in the Y-axis direction, to obtain a changed value of the parameter in the Y-axis direction; and
a touch point coordinate locating module configured to determine orthogonal coordinates constituted by the coordinate of the peak location in the X-axis direction and the coordinate of the peak location in the Y-axis direction as coordinates of the touch point, if both the changed value of the parameter in the X-axis direction and the changed value of the parameter in the Y-axis direction are larger than the respective preset threshold values.

13. An electronic equipment comprising a display unit and a device for locating a touch point on a touch region having a plurality of partitions, wherein the device comprises:
a detecting and acquiring module configured to detect a current value of a parameter of each partition and acquire a reference value of the parameter and a preset threshold value of the parameter;
a touched partition determining module configured to determine a touched partition according to the current value of the parameter, the reference value of the parameter and the preset threshold value; and
a scanning and locating module configured to scan the touched partition to locate at least one touch point.
